(19) United States
(12) Patent Application Publication
(10) Pub. No.: US 2013/0316099 A1
(43) Pub. Date: Nov. 28, 2013

(54) STAND-OFF CONSTRUCTION FOR VACUUM INSULATED GLASS

(71) Applicant: EVERSEALED WINDOWS, INC., Evergreen, CO (US)

(72) Inventors: SETH A. MILLER, Englewood, CO (US); WILLIAM H. FRANCIS, IV, Boulder, CO (US)

(73) Assignee: EVERSEALED WINDOWS, INC., Evergreen, CO (US)

(21) Appl. No.: 13/829,107

(22) Filed: Mar. 14, 2013

Related U.S. Application Data
(60) Provisional application No. 61/650,343, filed on May 22, 2012.

(51) Int. Cl. E06B 3/663; E06B 3/673

(52) U.S. Cl. CPC E06B 3/66304; E06B 3/67304; E06B 3/67326
USPC 428/34; 427/289; 156/109; 205/152

(57) ABSTRACT

A stand-off is necessary to separate two glass lites (panes of glass) in a vacuum insulated glazing system. This stand-off must provide sufficient mechanical support to keep the lites apart despite one atmosphere pressure pushing the lites together. For systems that are designed with flexible edge seals, there will be movement of one lite relative to the other during diurnal cycling, and the stand-offs will therefore be scraped against at least one of the lite surfaces. Because many mechanically robust materials suitable for stand-offs have high friction, it is beneficial to apply a lubricant to the surface of the stand-off. However, it is also beneficial to adhere the stand-off to one lite during the manufacturing operation, and this need opposes the need for good lubricity. This invention describes means for optimizing the composition of a stand-off to meet these conflicting needs.

### CROSS-REFERENCE TO RELATED APPLICATIONS

This application claims benefit of U.S. Provisional Application No. 61/650,343, filed May 22, 2012, entitled STAND-OFF CONSTRUCTION FOR VACUUM INSULATED GLASS (Atty. Dkt. No. STRK-31279), the specification of which is incorporated herein in its entirety.

### TECHNICAL FIELD

The current invention relates to multi-pane vacuum insulating glass units (VIGUs) for use in fenestration applications (e.g., windows and doors for buildings); windows for transportation vehicles (e.g., buses, trucks, automobiles, planes, trains, ships); solar collector panels; supermarket refrigeration systems; beverage vending machine glass units; and any other application where a VIGU might be used.

### BACKGROUND

Vacuum insulated glass units (VIGUs) are of interest for window applications because of their extremely high insulating properties, with center-of-glass R values as high as R 13 or more. Referring to FIGS. 1a and 1b, a VIGU is composed of two glass sheets 130 and 170, between which are disposed a series of stand-offs 140. Around the edge of the VIGU is a sealing system composed of compliant members 110 and rigid members 190. The VIGU is evacuated through a pump-out tube (not shown) which would be hermetically bonded above a hole on glass surface 131 or below glass surface 173. The pump-out tube would be pinched off after the VIGU is evacuated to a pressure of 1×10⁻³ torr or below. The stand-offs are shown as items 140.

Once the VIGU is evacuated, the glass sheets are subject to one atmosphere of pressure on both sides of the unit. The role of the stand-offs in between the glass sheets (lites) is to prevent the lites from bowing inward and touching each other under this pressure, as direct physical contact between the sheets will result in a thermal short that degrades the windows insulating performance. Further, the high stresses pressing inwards on the glass can result in glass breakage.

The stand-offs themselves also create a thermal path between the two lites. Therefore it is particularly advantageous to use as few as stand-offs as possible, with minimum cross-sectional area in contact with the glass. This requirement means that there is intense compressive force placed on each stand-off, and the stand-offs must have a sufficiently high compressive yield strength to accommodate the large loads.

Further, during diurnal cycling of the windows, the outer lite will be exposed to the outside environment, and become relatively hotter and/or colder than the inner lite. This relative expansion/contraction of the outer lite versus the inner lite means that the stand-offs will scrape back and forth across one or both lites during thermal cycling. For VIGUs designed with a flexible edge seal, the stand-offs can travel as much as 0.5 mm during cycling of a 1 m² unit in an extreme climate such as Eli, Nev. Thus, it is critical to ensure that the interface between the stand-off and the glass is sufficiently lubricated that the glass or any coating on the glass is not scratched or otherwise damaged during this cycling.

Finally, these stand-offs must be applied to at least a first glass sheet during VIGU fabrication, where the second sheet is disposed atop the stand-offs before sealing. For stand-offs that adhere poorly to the glass, it becomes difficult to handle the glass after stand-off placement, and this imposes significant restrictions on the manufacturing flow of the VIGU. If the stand-offs are not bonded to the VIGU, the window should not be moved before vacuum is applied (after which the pressure of the glass on the stand-offs hold them in place). Any technology for bonding the stand-offs to glass requires that a completely non-outgassing material be used for the stand-off and its lubricant coating, and that a very simple manufacturing flow be employed. As a result, in the literature there is no simple means suggested for bonding stand-offs to glass prior to subsequent handling.

It is the purpose of this invention to describe a stand-off construction and means for manufacturing stand-offs and VIGUs with stand-offs that resolve many of the aforementioned problems.

### SUMMARY

In one embodiment of this invention, a stand-off for a VIGU is created whose bulk compressive yield strength is between 300 MPa (Mega-Pascal) and 900 MPa, preferably between 500 MPa and 700 MPa.

In yet another embodiment of the invention, a stand-off for a VIGU is created using a low-friction coating with a melting point ≦250° C. In one such embodiment, the coating is composed of indium. In another embodiment, the coating is composed of an indium/tin alloy. In one embodiment, the alloy is 48% indium and 52% tin by weight. In another embodiment, the alloy is approximately 96% tin, 4% silver by weight.

In yet another embodiment of the invention, the low-friction coating layer is deposited onto the bulk stand-off material using electro-deposition (electrolytic deposition) in a solution plating bath. In another embodiment of the invention, the coating is deposited onto the stand-off material using electroless deposition in a solution plating bath. In one embodiment of the invention, more than one layer is deposited onto the bulk stand-off material, and these two or more deposited layers alloy on heating to form a single layer with a lower melting point than any of the layers alone.

In yet another embodiment of the invention, a sheet of bulk stand-off material is coated using electroless deposition or electro-deposition (electrolytic deposition) in a solution plating bath. In this embodiment, coated (plated) sheet is later punched into individual stand-offs using a stamping or metal-punching process.

In another embodiment of the invention, the stand-offs are placed onto a single glass sheet, and the stand-offs are heated above the melting point of the coating. In this embodiment of the invention, this heating occurs before the two sheets are joined to form a cavity. In this embodiment of the invention, the stand-offs are more strongly adhered to the glass after this heating process than they were before this heating process.

In yet another aspect, a vacuum insulated glass unit comprises a first glass sheet having an inner surface and an outer surface, a second glass sheet having an inner surface and an outer surface, and a plurality of stand-offs disposed in the cavity. The inner surface of the second glass sheet is disposed substantially parallel to, but spaced apart from, the inner surface of the first glass sheet so as to define a cavity therebetween. The plurality of stand-offs is formed from material having a bulk compressive yield strength. Each stand-off has a first contact surface in contact with the inner surface of the first glass sheet and a second contact surface in contact with the inner surface of the second glass sheet. At least one of the first and second contact surfaces of each stand-off includes a low-friction coating layer.

In another embodiment, the material of the plurality of stand-offs has a bulk compressive yield strength within the range from 300 MPa to 900 MPa.

In yet another embodiment, the material of the plurality of stand-offs has a bulk compressive yield strength within the range from 500 MPa to 700 MPa.

In another embodiment, the material of the low-friction coating layer has a melting point of 250° C. or less.

In another embodiment, the material of the low-friction coating layer comprises indium.

In another embodiment, the material of the low-friction coating layer comprises an indium/tin alloy.

In another embodiment, the indium/tin alloy is 48% indium and 52% tin by weight.

In still another embodiment, the material of the low-friction coating layer comprises an alloy that is approximately 96% tin and 4% silver by weight.

In another aspect, a method of forming stand-offs for a vacuum insulated glass unit, comprises the following steps: providing a bulk stand-off material in the form of a sheet or foil; depositing a low-friction coating layer onto an outer surface of the bulk stand-off material; and forming individual stand-offs having a low-friction coating by stamping or punching circular disks from the coated bulk stand-off material.

In another embodiment, the bulk stand-off material is one of stainless steel, 17/4 PH stainless steel, 401 stainless steel fully hardened and 401 stainless steel ¾ hardened.

In yet another embodiment, the low-friction coating is deposited onto the outer surface of the bulk stand-off material using electro-deposition (electrolytic deposition) in a solution plating bath.

In another embodiment, the low-friction coating is deposited onto the outer surface of the bulk stand-off material using electroless deposition in a solution plating bath.

In another embodiment, the step of depositing the low-friction coating onto the outer surface of the bulk stand-off material further comprises: depositing at least two original layers of different coating materials onto the bulk stand-off material; and heating the bulk material to alloy the at least two original layers to form a single resulting layer with a lower melting point than any of the original layers alone.

In still another embodiment, a sheet of bulk stand-off material is coated using one of electroless deposition or electro-deposition (electrolytic deposition) in a solution plating bath; and the coated sheet is later punched into individual stand-offs using a stamping or metal-punching process.

In yet another aspect, a method of forming a vacuum insulated glass unit, the method comprises the following steps: (a) providing a first glass sheet having an inner surface and an outer surface; (b) placing a plurality of stand-offs on the inner surface of the first glass sheet, each stand-off having a first contact surface in contact with the inner surface of the first glass sheet and a second contact surface opposite the first contact surface, the first contact surface including a coating layer formed of a material having a melting temperature; (c) heating the first glass sheet with the stand-offs placed thereon to a first temperature above the melting temperature of the coating layer, and then cooling the first glass sheet and the stand-offs to a second temperature below the melting temperature; and (d) providing a second glass sheet having an inner surface and an outer surface, and placing the inner surface of the second glass sheet against the second contact surfaces of the stand-offs such that the second glass sheet is disposed substantially parallel to, but spaced apart from, the inner surface of the first glass sheet so as to define a cavity therebetween, the placing of the second glass sheet occurring after the heating and cooling step (c).

In another embodiment, after the heating and cooling step (c), the stand-offs are more strongly adhered to the first glass sheet than they were before the heating and cooling step (c).

### BRIEF DESCRIPTION OF THE DRAWINGS

For a more complete understanding, reference is now made to the following description taken in conjunction with the accompanying Drawings in which:

FIGS. 1a and 1b show a schematic view of the components of a VIGU before and after assembly;

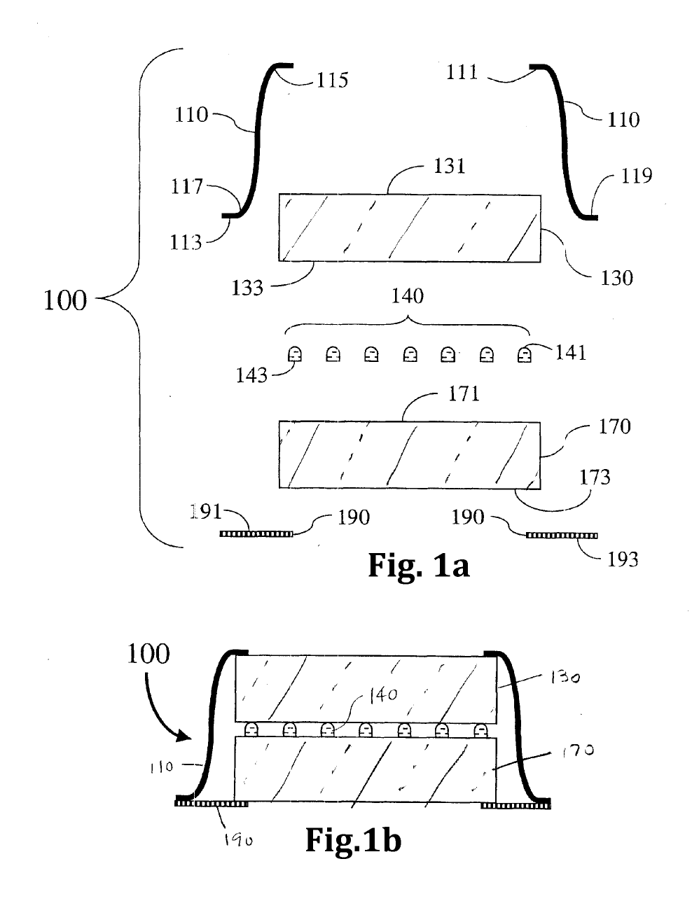

FIG. 2 illustrates the forces applied to a stand-off in a VIGU;

FIGS. 3a and 3b are photographs of a stand-off before and after application of a compressive load, respectively;

FIG. 4 is a graph of testing of the compressive force that can be applied to a stand-off on a piece of glass before the glass breaks; and

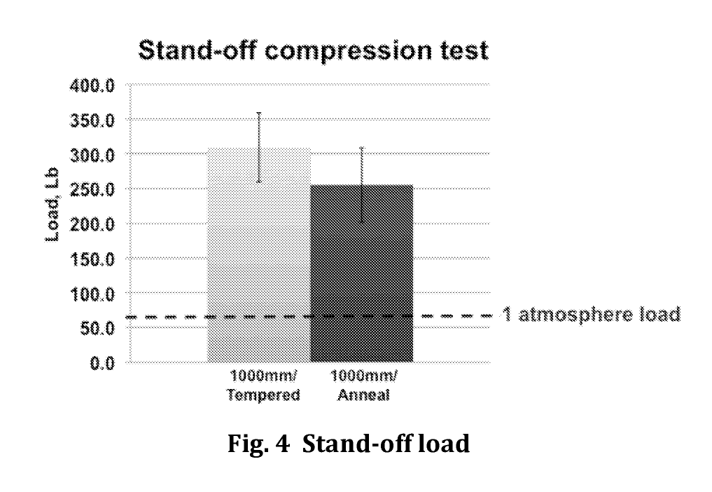

FIG. 5 is a graph of tribology testing of a stand-off with a low-friction coating.

### DETAILED DESCRIPTION

Referring now to the drawings, wherein like reference numbers are used herein to designate like elements throughout, the various views and embodiments of stand-off construction for vacuum insulated glass are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

In a VIGU, the stand-offs are subject to large compressive stresses as they maintain the separation of the two glass panels despite the constant force of atmospheric pressure. These stand-offs must be strong enough to not yield under this pressure.

Because the stand-offs represent a thermal path between the glass panels, and because the purpose of the VIGU is to provide good insulation, it is preferred to use as few stand-offs as possible, and to keep them widely spaced. Thus, a VIGU is typically designed at or near the mechanical tolerances of the glass itself. There must be sufficient margin against glass fracture to produce a reliable VIGU, but the thermal performance must be sufficiently high that the VIGU has a competitive insulating performance, preferably allowing a whole window value to be R-8 or better.

Glass is mechanically limited by its tensile strength, and stresses in excess of its ultimate tensile strength result in fracture of the glass and failure of the VIGU. In a VIGU, the tensile stresses result from compression of the stand-off into the glass surface: the greatest tensile stresses form in the regions of the glass directly adjacent to the perimeter of the stand-off, and the regions of the glass opposite from the standoff. Thus, it is preferable to minimize these stresses to preserve the mechanical safety margin of the glass.

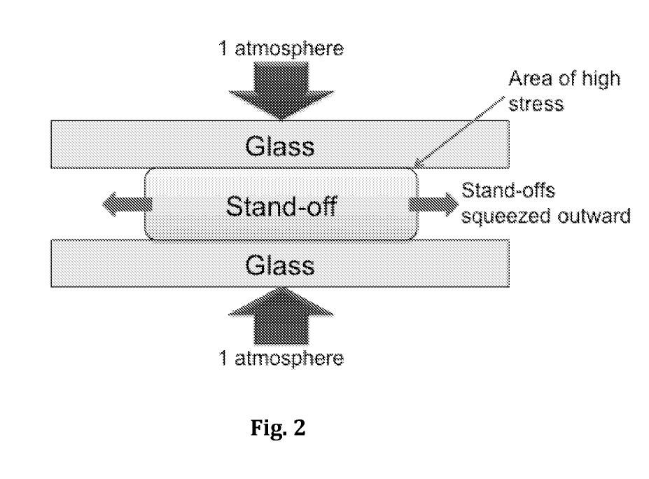

The largest stresses in a system accrue at the edge of the stand-off, at the glass-standoff interface, as shown in FIG. 2. Because the elastic modulus of the glass is not infinite, it is compressed inwards by the stand-off, and relaxes to its neutral state past the stand-off edge. Thus, there is a significant stress on the glass at this interface, creating tensile stresses that can lead to fracture of the glass. To minimize these stresses, it is preferred to have the standoff assume a slight dome shape where it touches the glass: the relaxation of the glass will thus be continuous across the curved dome of the stand-off, rather than discontinuous at the stand-off edge. By following this approach, the stresses in the glass at the stand-off edge will be smaller.

However, it is not simple to manufacture such a stand-off. For example, one method of producing a stand-off is to punch the material from a metal sheet. This method is very inexpensive, and creates stand-offs that are circular, with a small chamfer at the edge. However, once created these stand-offs cannot be machined. Thus, the stand-offs created by metal punching will deliver a geometry that is not ideal for the VIGU.

We have designed an innovative solution to the problem, by carefully selecting the compressive yield strength of the stand-offs' bulk material. In our invention, the standoff's compressive yield strength lies above the normal carrying pressure of the stand-offs (with one atmosphere of pressure on the outside lites), but below the maximum pressures that will break the glass. As a result, applied pressures will result in yielding of the stand-offs before initiating cracking of the glass. This allows the stand-offs to relieve stress and form the ideal domed geometry in situ, so that there is no need to fabricate the stand-offs with an ideal geometry before placement.

Further, these stand-offs are excellent at dissipating transient loads, such as those created by shock, for example as a result of a bird strike. If a load exceeds the maximum carrying capacity of the stand-offs, the stand-offs flow plastically under the load rather than transferring the load to the glass itself.

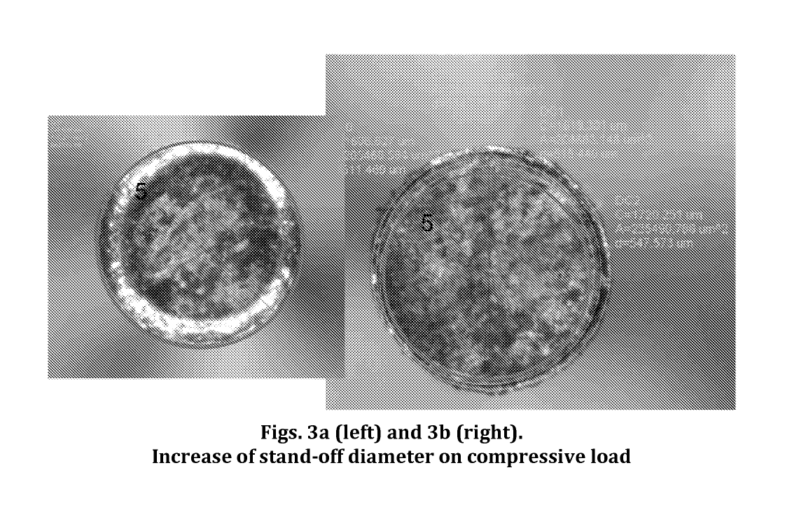

As a stand-off flows outwards under a compressive load above its yield strength, its radius increases, as shown in FIGS. 3a and 3b. This increase in the stand-off area serves to lower the total force (expressed in psi) that the stand-off experiences, and thereby provides further margin against glass fracture.

Overall, the net result is that if the stand-off compressive yield strength is selected according to the teachings of this invention, the VIGU will be able to withstand far greater static and transient loads than it would for a stronger, higher compressive-strength stand-off. For example, it has been taught by others to use a stand-off with compressive yield strength of above 1 GPa (Giga-Pascal), so that the glass will fail before the stand-off yields. In our work, however, we prefer a stand-off with compressive yield strength between 300 and 900 MPa (Mega-Pascal), and more preferably between 500 and 700 MPa.

The yield strength can be achieved through proper selection of stand-off material. In one embodiment, the bulk of the stand-off material is composed of 17/4 PH stainless steel (SS). In another embodiment, the bulk of the stand-off material is 401 SS fully hardened. In another embodiment, the bulk of the stand-off material is 401 SS ¾ hardened.

When the VIGU is deployed in the field, it will experience a temperature gradient from the outer lite to the inner lite. Because the thermal expansion coefficient of glass is greater than zero, the two lites will not have exactly the same size: As the outer lite heats during the day, it will expand; as it cools at night, it will contract. As a result, stand-offs disposed between those two lites will move relative to at least one of the lites. Thus, the tribology at the glass-metal interface must be considered when designing a VIGU.

It has been taught previously in the literature that a low-friction coating on the stand-off is beneficial to reduce friction and wear between the two surfaces. However, at the same time, it would be beneficial to mechanically anchor the stand-offs to the glass, so that the glass can be handled during manufacturing without any stand-offs falling off of the glass. These two constraints—both low friction and mechanical anchoring—are diametrically opposed, and thus there has not previously been a solution that allows both mechanical anchoring and low friction.

It is thus surprising to note that thin films of low melting temperature alloys, particularly those containing indium or bismuth, anchor effectively to glass yet provide for good lubricity. This is because of the particular mechanism for friction reduction in these films: the materials themselves are actually quite adherent, but when they are coated to conform to a first rough surface, they will have very little total surface area in contact with any other surface that they are placed against. Further, because these low melting alloys have low shear strength, they will fail cohesively when rubbed, allowing for easy sliding. This combination of low contact area and low strength makes for an ideal lubricant, with an exemplary coefficient of friction of 0.1 or less.

However, when these materials are placed in full surface area contact with a substrate, their adhesion for that substrate is quite high, with a coefficient of friction of 0.7 or higher. Thus, the same material can be adherent in one circumstance, and lubricious in another.

We have used this unique set of properties to anchor the stand-off to the substrate while maintaining lubricity. In our process, we first dispose stand-offs coated with a low melting alloy in a grid pattern on the glass, using a technique such as manual or automatic pick-and-place. We then heat the stand-offs above the melting point of the stand-off alloy. This can be done by, for example, heating the glass and stand-offs together in an oven or on a hot plate. Alternatively, this can be accomplished by heating the stand-off assembly using an IR lamp. In another embodiment, this is accomplished by using a point heating source such as an IR or visible laser to heat each stand-off individually. In all cases, the coating on the stand-off melts and flows, so that it makes contact to the glass over the entire surface area of the stand-off. This is sufficient to enable good adhesion of the stand-off to the glass, and the stand-offs do not slide when lightly pushed parallel to the glass surface.

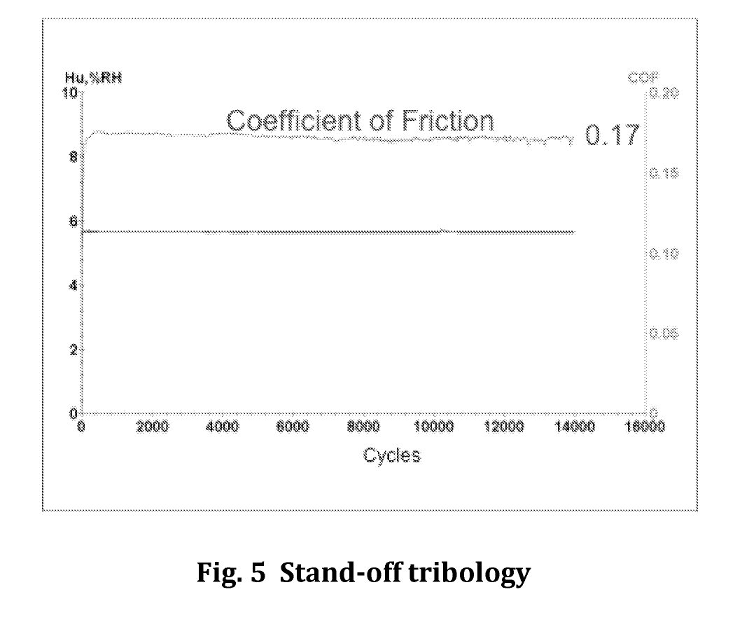

Despite these attachment processes, the side of the stand-off that does not touch the glass during this process maintains a rough, low friction surface, so that it has a coefficient of friction of <0.1. This is illustrated in FIG. 5, which shows a measurement of the coefficient of friction of such a stand-off over 14,400 cycles, corresponding to 40 years of thermal cycling at a rate of once per day in a dry air environment. In this experiment, a set of three stand-offs were anchored to a first piece of glass using the above procedure, and then pressed against a second piece of glass, which was cycled at a rate of 1 Hz. The stand-offs maintained their lubricity even through 40 years of simulated life.

To prepare these stand-offs, the preferred procedure is to obtain a thin foil of metal, e.g., a 125 μm thick foil of 401 SS ¾ hardened. This foil is then coated by in a solution plating bath by electro-deposition or electroless metal deposition. In one embodiment, the foil is coated with 2 μm nickel using electroless deposition, then with 1 μm indium metal using electro-deposition. In another embodiment, the foil is coated with nickel, then with about 1 μm of tin, then about 1 μm of indium. In this example, the tin and indium form an alloy when heated, so that no distinct interface remains between the two metals. In a preferred embodiment, the ratio between tin and indium is 52:48. In another embodiment, the ratio between tin and indium is 58:42. In another example, bismuth is electrodeposited instead of indium. This can be applied to create a tin/bismuth alloy, for example at a ratio of about 42:58 tin-bismuth. In another embodiment, a combination of tin, indium, and bismuth can be used. In another example, a combination of tin and silver is used. In general, it is preferable to use a metal or an alloy with a melting point at or below 250° C., in order to reduce the stresses that develop between the glass and the stand-off alloy during cooling, as will be described below. It is most preferable to use an alloy with a melting point at or below 200° C., or below 175° C.

The coated metal foil is then stamped into small circles, which are used as stand-offs. In a preferred embodiment, the stand-offs are between 300 μm in diameter and 2 mm in diameter. In a more preferred embodiment, the stand-offs are between 500 μm in diameter and 1 mm in diameter.

In another embodiment of this invention, these stand-offs are applied to the glass in a defined pattern. In one embodiment of this invention, this defined pattern is a square grid. This square grid can be at a number of different spacings, for example at 1″ spacings, 1.5″ spacings, 2″ spacings, etc. In a preferred embodiment, the stand-offs are in a grid at about a 2″ spacing. In a preferred embodiment, the glass used is tempered glass, with a compressive strength of at least 15 Ksi.

In another embodiment of this invention, the glass and stand-offs are heated together, for example in an oven or on a hot plate. In a preferred embodiment, the heating step raises the temperature of the stand-offs to at about 10° C. or more above the melting temperature of the coating material or the lower-melting material present in multi-layer coatings, for example about 10° C. or more above 157° C. for indium, and about 10° C. or more above 232° C. for tin, etc. In another embodiment, the glass is maintained below the melting point of the coating materials, and the coatings themselves are heated using one of or a combination of an forced convection, IR lamp, IR laser, microwave radiation, inductive heating or other heating sources, such that the stand-offs are heated to a greater temperature than the glass. In another embodiment, ultrasonic energy is applied to the glass or stand-off during the heating process, in order to improve wetting of the metal to the glass.

In one embodiment of the invention, this heating of the stand-offs occurs on a single sheet of glass, for example before the two sheets are joined to form a cavity. In another embodiment of this invention, a second sheet of glass is placed on top of the stand-offs before heating.

In one embodiment of the invention, the stand-offs are more strongly adhered to the glass after this heating process than they were before this heating process. Despite this strong adherence, the stand-off coating still functions as an effective lubricant, reducing the coefficient of friction of the coated stand-off versus glass or a pre-deposited coating on the glass so that coefficient of friction of the coated stand-off is less than the coefficient of friction of an uncoated stand-off versus glass or coated glass. Thus, this invention simultaneously provides for both adherence to one lite and low friction to the other, overcoming the manufacturability limitations of previous approaches.

Although the preferred embodiment has been described in detail, it should be understood that various changes, substitutions and alterations can be made therein without departing from the spirit and scope of the invention as defined by the appended claims.

It will be appreciated by those skilled in the art having the benefit of this disclosure that this stand-off construction for vacuum insulated glass provides a vacuum insulated glass unit—John, please double check description. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. A vacuum insulated glass unit comprising:
a first glass sheet having an inner surface and an outer surface;
a second glass sheet having an inner surface and an outer surface, the inner surface of the second glass sheet being disposed substantially parallel to, but spaced apart from, the inner surface of the first glass sheet so as to define a cavity therebetween; and
a plurality of stand-offs disposed in the cavity, the plurality of stand-offs being formed from material having a bulk compressive yield strength, each stand-off having a first contact surface in contact with the inner surface of the first glass sheet and a second contact surface in contact with the inner surface of the second glass sheet;
wherein at least one of the first and second contact surfaces of each stand-off includes a low-friction coating layer.

2. A vacuum insulated glass unit in accordance with claim 1, wherein the material of the plurality of stand-offs has a bulk compressive yield strength within the range from 300 MPa to 900 MPa.

3. A vacuum insulated glass unit in accordance with claim 2, wherein the material of the plurality of stand-offs has a bulk compressive yield strength within the range from 500 MPa to 700 MPa.

4. A vacuum insulated glass unit in accordance with claim 1, wherein the material of the low-friction coating layer has a melting point of 250° C. or less.

5. A vacuum insulated glass unit in accordance with claim 1, wherein the material of the low-friction coating layer comprises indium.

6. A vacuum insulated glass unit in accordance with claim 5, wherein the material of the low-friction coating layer comprises an indium/tin alloy.

7. A vacuum insulated glass unit in accordance with claim 6, wherein the indium/tin alloy is 48% indium and 52% tin by weight.

8. A vacuum insulated glass unit in accordance with claim 1, wherein the material of the low-friction coating layer comprises an alloy that is approximately 96% tin and 4% silver by weight,

9. A method of forming stand-offs for a vacuum insulated glass unit, the method comprising the following steps:
providing a bulk stand-off material in the form of a sheet or foil;
depositing a low-friction coating layer onto an outer surface of the bulk stand-off material; and
forming individual stand-offs having a low-friction coating by stamping or punching circular disks from the coated bulk stand-off material.

10. A method of forming stand-offs in accordance with claim 9, wherein the bulk stand-off material is one of stainless steel, 17/4 PH stainless steel, 401 stainless steel fully hardened and 401 stainless steel ¾ hardened.

11. A method of forming stand-offs in accordance with claim 9, wherein the low-friction coating is deposited onto the outer surface of the bulk stand-off material using electro-deposition (electrolytic deposition) in a solution plating bath.

12. A method of forming stand-offs in accordance with claim 9, wherein the low-friction coating is deposited onto the outer surface of the bulk stand-off material using electroless deposition in a solution plating bath.

13. A method of forming stand-offs in accordance with claim 9, wherein the step of depositing the low-friction coating onto the outer surface of the bulk stand-off material further comprises:
depositing at least two original layers of different coating materials onto the bulk stand-off material; and
heating the bulk material to alloy the at least two original layers to form a single resulting layer with a lower melting point than any of the original layers alone.

14. A method of forming stand-offs in accordance with claim 9, wherein:
a sheet of bulk stand-off material is coated using one of electroless deposition or electro-deposition (electrolytic deposition) in a solution plating bath; and
the coated sheet is later punched into individual stand-offs using a stamping or metal-punching process.

15. A method of forming a vacuum insulated glass unit, the method comprising the following steps:
(a) providing a first glass sheet having an inner surface and an outer surface;
(b) placing a plurality of stand-offs on the inner surface of the first glass sheet, each stand-off having a first contact surface in contact with the inner surface of the first glass sheet and a second contact surface opposite the first contact surface, the first contact surface including a coating layer formed of a material having a melting temperature;
(c) heating the first glass sheet with the stand-offs placed thereon to a first temperature above the melting temperature of the coating layer, and then cooling the first glass sheet and the stand-offs to a second temperature below the melting temperature; and
(d) providing a second glass sheet having an inner surface and an outer surface, and placing the inner surface of the second glass sheet against the second contact surfaces of the stand-offs such that the second glass sheet is disposed substantially parallel to, but spaced apart from, the inner surface of the first glass sheet so as to define a cavity therebetween, the placing of the second glass sheet occurring after the heating and cooling step (c).

16. A method of forming a vacuum insulated glass unit in accordance with claim 15, wherein after the heating and cooling step (c), the stand-offs are more strongly adhered to the first glass sheet than they were before the heating and cooling step (c).
